(19) United States
(12) Patent Application Publication
(10) Pub. No.: US 2024/0283201 A1
(43) Pub. Date: Aug. 22, 2024

(54) Systems Configured to Operate with Multiple Different Voltages

(71) Applicant: Rheem Manufacturing Company, Atlanta, GA (US)

(72) Inventor: Ryan Andrew Hunter, San Antonio, TX (US)

(21) Appl. No.: 18/407,591

(22) Filed: Jan. 9, 2024

Related U.S. Application Data
(60) Provisional application No. 63/485,410, filed on Feb. 16, 2023.

(51) Int. Cl. H01R 24/28; H01R 13/639; H01R 13/66

(52) U.S. Cl. CPC H01R 24/28; H01R 13/6392; H01R 13/665

(57) ABSTRACT

A device is disclosed for use with a detachable power cord having a plug. In certain embodiments, the device includes a receptacle configured to receive the plug, a circuit configured to determine a maximum operating parameter of the detachable power cord, and a controller configured to operate a function of the device based on the determined maximum operating parameter of the detachable power cord.

### CROSS-REFERENCE TO RELATED APPLICATIONS

This application claims priority to and the benefit of U.S. provisional application No. 63/485,410, filed Feb. 16, 2023, which is hereby incorporate by reference in its entirety.

### FIELD

This disclosure relates generally to systems configured to operate with multiple different voltages.

### BACKGROUND

Packaged terminal air conditioning (PTAC) units are a type of self-contained heating and air conditioning system commonly found in hotels, motels, apartment buildings, etc. Many are designed to go through a wall, having vents and heat sinks both inside and outside of a conditioned space.

In many cases, a single PTAC unit may be configured to operate from a plurality of voltage sources. In particular, a single PTAC unit may be configured to operate from a voltage outlet providing 120 V, 220V, 208 V, or 230V alternating current. In these PTAC units, however, a technician/installer may need to adjust parameters for the working components, such as the heater, the fan, and the compressor, for each respective supplied voltage. Therefore, even if a PTAC unit may be universally usable with many different supplied voltages, much service may be needed to configure a PTAC for any particular supplied voltage.

What is needed is a PTAC unit that can be automatically configured to operate with one of multiple different voltages.

### BRIEF DESCRIPTION OF THE DRAWINGS

The detailed description is set forth with reference to the accompanying drawings. In some instances, the use of the same reference numerals may indicate similar or identical items. Various embodiments may utilize elements and/or components other than those illustrated in the drawings, and some elements and/or components may not be present in various embodiments. Throughout this disclosure, depending on the context, singular and plural terminology may be used interchangeably.

FIG. 1A illustrates a front perspective view of a PTAC unit in accordance with one or more embodiments of the present disclosure.

FIG. 1B illustrates a front perspective view of the PTAC unit of FIG. 1A with a moveable cover removed in accordance with one or more embodiments of the present disclosure.

FIG. 2 illustrates a block diagram of the PTAC unit of FIG. 1A and a power cord in accordance with one or more embodiments of the present disclosure.

FIG. 3 illustrates the controller of the PTAC unit of FIG. 2 in accordance with one or more embodiments of the present disclosure.

FIG. 4 illustrates an exploded view of an example power cord in accordance with one or more embodiments of the present disclosure.

FIG. 5 illustrates an exploded view of an example power cord in accordance with one or more embodiments of the present disclosure.

FIG. 6 illustrates a voltage divider in accordance with one or more embodiments of the present disclosure.

FIG. 7A illustrates a look-up table in accordance with one or more embodiments of the present disclosure.

FIG. 7B illustrates a look-up table in accordance with one or more embodiments of the present disclosure.

FIG. 8 illustrates another example controller of the PTAC unit of FIG. 2 in accordance with one or more embodiments of the present disclosure.

FIG. 9 illustrates a method of operating the PTAC unit of FIG. 2 in accordance with one or more embodiments of the present disclosure.

### DETAILED DESCRIPTION

This disclosure relates generally to air conditioning units and more particularly to air conditioning units configured to operate automatically with one of multiple different voltages. In some instances, the air conditioning unit may be a PTAC unit, a mini split, a window unit, or the like. Any suitable air conditioning unit may be used herein. In some instances, the air conditioning unit includes a receptacle configured to receive a plug of a detachable power cord. The plug of the detachable power cord includes an element associated with the type of power cord, e.g., a 120 V power cord, a 220 V power cord, 208 V power cord, or 230 V power cord, etc., from a power source. The receptacle of the air conditioning unit includes or is otherwise associated with a controller that is able to determine the type of power cord based on the element in the plug. By determining the type of power cord, the controller is adapted to automatically configure the working components, such as the heater, the fan, and the compressor, to operate in accordance with the voltage to be supplied by the power cord.

In certain embodiments, the plug includes an impedance element associated with the type of power cord and the air conditioning unit includes a look up table associated with many different types of power cords with the corresponding operating parameters to configure the working components, such as the heater, the fan, and the compressor. When the controller of the air conditioning unit determines the power cord that is plugged in, the controller determines and configures the operating parameters of the working components, such as by limiting the amount of current to be drawn by each component. Other operating parameters include the maximum voltage for which a component may operate.

In this manner, an air conditioning unit in accordance with one or more embodiments of the present disclosure can be automatically configured to operate with one of multiple different voltages.

Although certain examples of the disclosed technology are explained in detail herein, it is to be understood that other examples, embodiments, and implementations of the disclosed technology are contemplated. Accordingly, it is not intended that the disclosed technology is limited in its scope to the details of construction and arrangement of components expressly set forth in the following description or illustrated in the drawings. The disclosed technology can be implemented in a variety of examples and can be practiced or carried out in various ways. In particular, the presently disclosed subject matter is described in the context of being air conditioning unit for use with a detachable power cord having a plug. The present disclosure, however, is not so limited, and can be applicable in other contexts, including any suitable systems (including units, devices, apparatuses, etc.). The present disclosure, for example and not limitation, can include other residential, commercial, or industrial air conditioning systems (such as horizontal or vertical window or wall units, HVAC unit, split unit, heat pumps, boilers, etc.), residential, commercial, or industrial water heater systems (such tank systems or tankless systems that use gas burners, electric heaters, heat pumps, or a combination thereof, industrial water heaters, and other systems that include a detachable power cord having a plug for various purposes. Such implementations and applications are contemplated within the scope of the present disclosure. Accordingly, when the present disclosure is described in the context of being a system and method for air conditioning units with a detachable power cord having a plug, it will be understood that other implementations can take the place of those referred to.

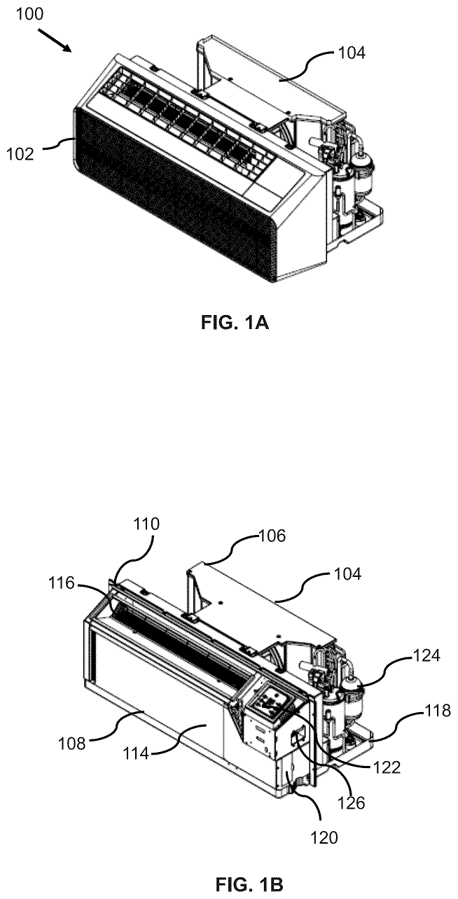

Turning now to the drawings, FIG. 1A illustrates a front perspective view of a PTAC unit 100 in accordance with one or more embodiments of the present disclosure. The PTAC unit 100 may include a working body 104 and a moveable cover 102. The working body 104 and moveable cover 102 may be any suitable size, shape, or configuration. In some instances, the total height and width of the PTAC unit 100 may be about 16 inches in height and about 42 inches in width.

FIG. 1B illustrates a front perspective view of the working body 104 of the PTAC unit 100. The working body 104 may include an external portion 106, an internal portion 108, a central flange 110 arranged to separate the external portion 106 and the internal portion 108, and a base pan 118. The working body 104 may be configured to be disposed in a wall sleeve within a wall. In this manner, at least a portion of the working body 104 may be located in an internal area (e.g., a room in a building or an apartment) in which the air therein is to be conditioned. Similarly, at least a portion of the working body 104 may be located in an external area (e.g., outside of the building). For example, the central flange 110 may divide the working unit into a first portion 115 including the internal portion 108 and a second portion 117 including the external portion 106. The first portion 115 of the working unit 104 may be disposed within the interior area, and the second portion 117 of the working unit 104 may be disposed within the external area.

In certain embodiments, the internal portion 108 may include an internal inlet 114, an internal outlet 116, filter access panel 120, a control panel 122, a compressor and a receptacle 126. The internal inlet 114 may be configured to receive internal air from the internal area. The internal outlet 116 may be configured to output a mix of the internal air and external air back into the internal area. In some instances, the moveable cover 102 may be disposed over the internal inlet 114 and the internal outlet 116.

The filter access panel 120 may enable access to an internal air filter, as will be described in greater detail below. In some instances, the filter access panel 120 may be omitted. The control panel 122 may be configured to enable a user to operate and adjust parameters of the PTAC unit 100. For example, the control panel 122 may enable a user to adjust the temperature and fan speed of the PTAC unit 100. The control panel 122 may enable a user to operate and adjust any suitable parameters of the PTAC unit 100 and provide additional functionality.

The compressor 124 circulates a refrigerant for heat exchange through the coils of the PTAC unit 100 and also to applies energy to the refrigerant or extracts energy from the refrigerant as needed.

The receptacle 126 is configured to receive a plug of a detachable power cord having a plug so as to provide power to the many components of the PTAC unit 100.

The PTAC unit 100 may be disposed within a wall sleeve in an exterior wall of a structure, such as a house, building, hotel, apartment, etc. In this manner, the exterior wall, in which the PTAC unit 100 may be disposed, may include an external side and an internal side. The external side may face the external area (e.g., outside of the building), and the internal side may face the internal area (e.g., a room inside the building). In this manner, the exterior wall separates the external area from the internal area. The central flange 110 may be configured to form a seal against the inner surface of a wall sleeve that is installed in the wall, so as to prevent internal air from the internal area from escaping to the outside and vice versa.

The base pan 118 supports the external portion 106 and the internal portion 108. The base pan 118 additionally acts as a reservoir to catch water from condensation as removed from the air by the PTAC unit 100. The base pan 118 may be any suitable size, shape, or configuration.

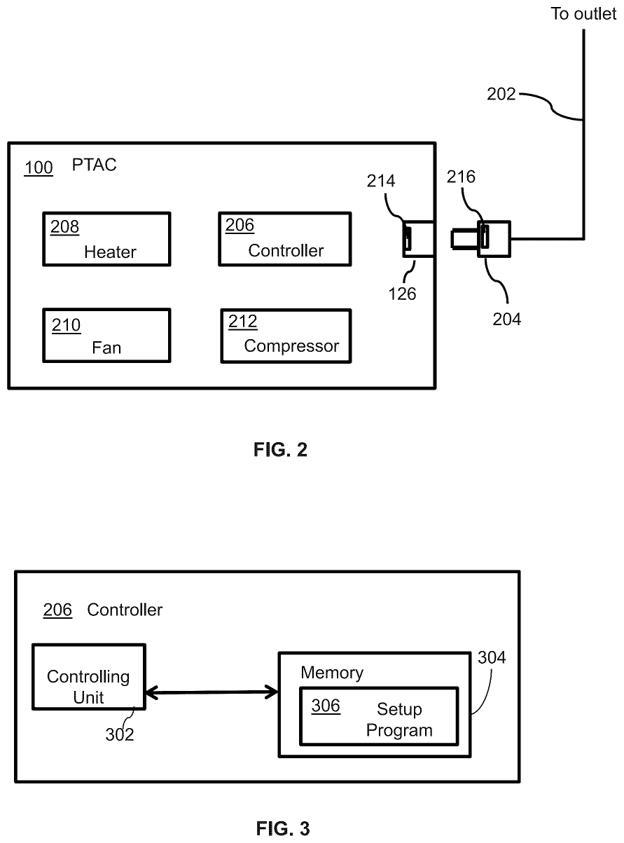

FIG. 2 illustrates a block diagram of the PTAC unit 100 of FIG. 1A and a power cord 202 in accordance with one or more embodiments of the present disclosure. The power cord 202 includes a length of wire having one end to plug into an outlet and another end having a plug 204. Within the plug 204 includes an impedance element 216. In some embodiments, the impedance element 216 is a resistor. However, in other embodiments, the impedance element may be any combination of a capacitive element, an inductive element, and/or a resistive element. Any suitable impedance element may be used herein. The power cord 202 may be any suitable size, shape, or configuration.

The PTAC unit 100 includes the receptacle 126, a controller 206, a heater 208, a fan 210, and a compressor 212. The receptacle 126 includes an impedance element 214. In some instances, the impedance element is a resistor. The impedance element may be any combination of a capacitive element, an inductive element, and/or a resistive element. Any suitable impedance element may be used herein. As mentioned above, the receptacle 126 is configured to receive the plug 204 so as to provide power to the PTAC 100.

The controller 206 controls operation of the heater 208, the fan 210, and the compressor 212. The heater 208 may be any suitable device or system that is able to generate heat, non-limiting examples of which include resistive heating elements, gas-fired heating elements, or combinations thereof. The fan 210 may be any suitable device or system (e.g., a blower or the like) that is able to move a volume of air through the PTAC 100 and back out into the room. The compressor 212 may be any suitable device or system that is able to compress and/or circulate a refrigerant for heat exchange through the coils of the PTAC unit 100.

In accordance with the present disclosure, the impedance element 216 is peculiar to the specific type of power cord. As will be described in greater detail below, the controller 206 of the PTAC 100 will have a priori information that identifies many types of power cords with many corresponding distinct impedance elements. Further, the controller 206 is able to detect the impedance of the impedance element 216. As a result, the controller 206 is able to identify the exact type of power cord for which the power cord 202 is used, e.g., a 120 V power cord, a 220 V power cord, 208 V power cord, or 230 V power cord, etc. Next, based on the power cord information, the controller 206 is able to configure the heater 208, the fan 210 and the compressor to operate based on the type of power cord being used.

FIG. 3 illustrates the controller 206 of the PTAC unit 100 of FIG. 2 in accordance with one or more embodiments of the present disclosure. The controller 206 includes a controlling unit 302 and a memory 304. The memory 304 has stored therein a setup program 306.

The controlling unit 302 and the memory 304 are illustrated as individual devices. However, in some embodiments, the controlling unit 302 and the memory 304 may be combined as a unitary device. Further, in some examples, the controlling unit 302 may be implemented as a computer having tangible computer-readable media for carrying or having computer-executable instructions or data structures stored thereon, which may include any computer program product, apparatus or device that can be used to carry or store desired computer-readable program code in the form of instructions or data structures and that can be accessed by a general-purpose or special-purpose computer, or a general-purpose or special-purpose processor

Such a computer system/server may be described in the general context of computer system-executable instructions, such as program modules, being executed by a computer system. Generally, program modules may include routines, programs, objects, components, logic, data structures, and so on that perform particular tasks or implement particular abstract data types. Further, such a computer system/server may be practiced in distributed cloud computing environments where tasks are performed by remote processing devices that are linked through a communications network. In a distributed cloud computing environment, program modules may be located in both local and remote computer system storage media including memory storage devices.

Components of an example computer system/server may include, but are not limited to, one or more processors or processing units, a system memory, and a bus that couples various system components including the system memory to the processor.

The controller 206 may be implemented as a hardware processor such as a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of the PTAC unit 100 in accordance with one or more embodiments of the present disclosure.

The memory 304 can store various programming and data. The setup program 306 includes instructions to enable the PTAC unit 100 to operate in accordance with one or more embodiments of the present disclosure.

In operation, returning to FIG. 2, when the plug 204 of the power cord 202 is plugged into the receptacle 126, the controller 206 determines the type of the power cord. In particular, as shown in FIG. 3, the controlling unit 302 executes instructions in the setup program 306 to cause the controller 206 to output a detection signal to the combination of the plug 204 and the receptacle 126.

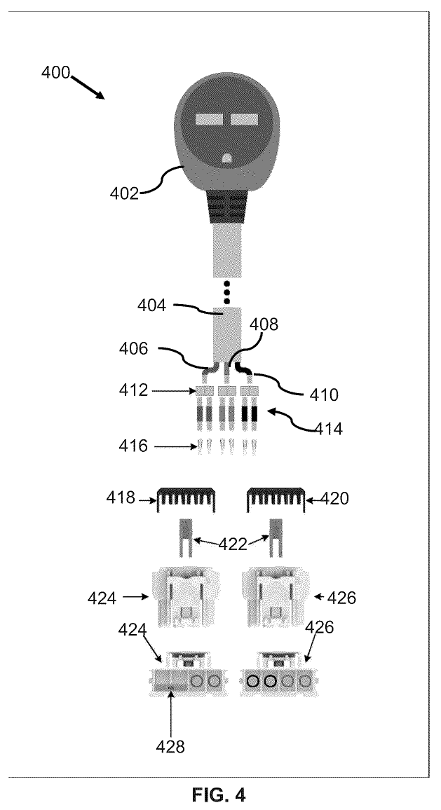

FIG. 4 illustrates an example power cord 400 in accordance with one or more embodiments of the present disclosure. The power cord 400 includes a plug 402 configured to be inserted into an outlet to receive power and a length of cord 404. At the end of the length of cord 404 are the internal wires, which in this example include a 12-guage ground wire 406, a 12-guage power wire 408, and a 12-guage neutral wire 410. The wires may be any suitable gauge. A set of connectors 412 connect the 12-guage ground wire 406, the 12-guage power wire 408, and the 12-guage neutral wire 410 to respective sets of double wire connectors 414. The double wire connectors 414 facilitate multiple connections to reduce the complexity of splitting of the wires, if needed, in the PTAC unit 100. In some instances, the wires may or may not be split.

The double wire connectors 414 are then crimped/bounded with respective crimping pins 416. Once crimped onto the respective wires, the crimping pins associated with the 12-guage ground wire 406 are inserted into a housing 424, whereas the crimping pins associated with the 12-guage power wire 408 and the crimp pins associated with the 12-guage neutral wire 410 are inserted into a housing 426. A terminal position assurance piece 418 maintains a position of the crimping pins associated with the 12-guage ground wire 406 within a housing 424, whereas a terminal position assurance piece 420 maintains a position of the crimping pins associated with the 12-guage power wire 408 and the crimp pins associated with the 12-guage neutral wire 410 within the housing 426. A connector position assurances 422 assure that the female terminals in housings 424 and 426 and the corresponding male terminals of the crimping pins 416 stay consistent relative to one another.

An impedance element 428 is disposed within housing 424. The impedance element 428 has and impedance that uniquely identifies the power cord 400. With this in mind, other power cords may be used in accordance with one or more embodiments of the present disclosure, wherein each power cord will include an impedance element that uniquely identifies that power cord.

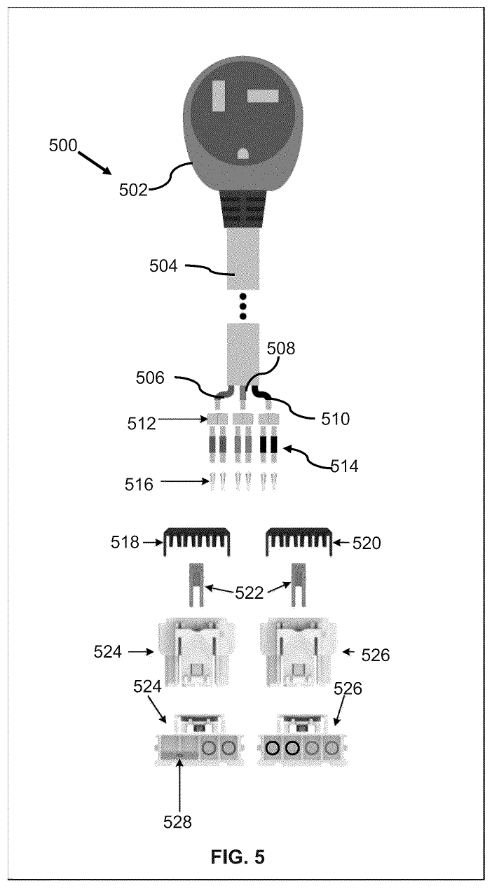

FIG. 5 illustrates another example power cord 500 in accordance with one or more embodiments of the present disclosure. The power cord 500 includes a plug 502 configured to be inserted into an outlet to receive power and a length of cord 504. The plug 502 has a different shape from that of plug 402 of FIG. 4 discussed above. In these examples, the plug 402 corresponds to NEMA 6-15P power cord, whereas the plug 502 corresponds to a NEMA 6-20P power cord. Any suitable NEMA power cord may be used herein.

At the end of the length of cord 504 are the internal wires, which in this example include a 12-guage ground wire 506, a 12-guage power wire 508, and a 12-guage neutral wire 510. A set of connectors 512 connect the 12-guage ground wire 506, the 12-guage power wire 508, and the 12-guage neutral wire 510 to respective sets of double wire connectors 514. The double wire connectors 514 facilitate multiple connections to reduce the complexity of splitting of the wires, if needed, in the PTAC unit 100. In some instances, the wires may or may not be split.

The double wire connectors 514 are then crimped/bounded with respective crimping pins 516. Once crimped onto the respective wires, the crimping pins associated with the 12-guage ground wire 506 are inserted into a housing 524, whereas the crimping pins associated with the 12-guage power wire 508 and the crimp pins associated with the 12-guage neutral wire 510 are inserted into a housing 526. A terminal position assurance piece 518 maintains a position of the crimping pins associated with the 12-guage ground wire 506 within a housing 524, whereas a terminal position assurance piece 520 maintains a position of the crimping pins associated with the 12-guage power wire 408 and the crimp pins associated with the 12-guage neutral wire 510 within the housing 526. A connector position assurances 522 assure that the female terminals in housings 524 and 526 and the corresponding male terminals of the crimping pins 516 stay consistent relative to one another.

An impedance element 528 is disposed within housing 524. The impedance element 528 has and impedance that uniquely identifies the power cord 500.

The controller 206 is configured to send a detection signal to the combination of the plug 204 and the receptacle 126. In some embodiments, the impedance element 216 of the plug 204 and the impedance element 214 of the receptacle 126 operate together as a voltage divider so that controller 206 may determine the impedance of the impedance element 216.

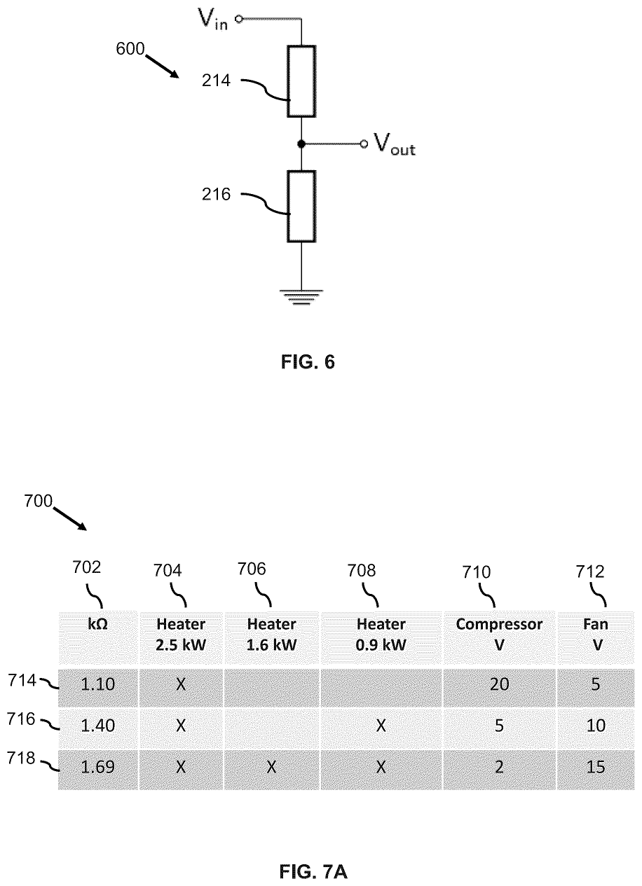

FIG. 6 illustrates a voltage divider 600 in accordance with one or more embodiments of the present disclosure. The voltage divider 600 includes the impedance element 214 of the receptacle 126 of the PTAC unit 100 in series with the impedance element 216 of plug 204 of power cord 202. The voltage divider 600 produces an output voltage, Vₒᵤₜ, that is a fraction of its input voltage, Vᵢₙ. The voltage division is the result of distributing the input voltage among the impedance element 214 and the impedance element 216. In this case, the impedance, Z₂₁₄, of the impedance element 214 may be known as it is part of the PTAC 100. Further, the input voltage, Vᵢₙ, provided by the controller 206 may be known, as it is preprogramed to be provided by the controller 206. The controller 206 may then detect the output voltage, Vₒᵤₜ. The output voltage, Vₒᵤₜ, is related to the input voltage in accordance with equation (1) as follows:

$${V}_{out} = {Z}_{216} / ( {Z}_{214} + {Z}_{216} ) * {V}_{in} . \qquad ( 1 )$$

The controller 206 is therefore able to determine the impedance, Z₂₁₆, of the impedance element 216 from equation (1) above.

Returning to FIG. 3, the controlling unit 302 is configured to then execute instructions in the setup program 306 to set the operating parameters for the heater 208, the fan 210, and the compressor 212 (or any other components) based on the identification of the impedance element 216. In particular, the setup program 304 may include a data structure that associates a detected impedance with a type of power cord, and further associates a type of power cord with operating parameters for the heater 208, the fan 210, and the compressor 212.

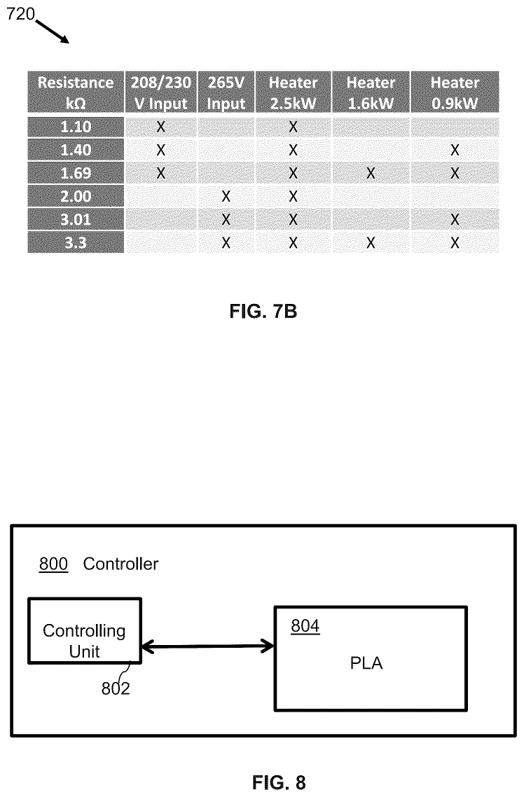

FIG. 7A illustrates an example look-up table (LUT) 700 in accordance with one or more embodiments of the present disclosure. The LUT 700 includes a column 702 of resistances in kilo-ohms, a column 704 of a 2.5 kW heater, a column 706 of 1.6 kW heater, a column 708 of a 0.9 kW heater, a column 710 of compressor voltage in volts, a column 712 of fan voltage in volts, and rows 714, 716 and 718 for different resistors.

Merely for purposes of discussion, and not to limit the present disclosure, presume that: 1.10 kΩ of row 714 corresponds to a three-wire grounded power cord used for 208 V and 240 V circuits rated for 15 amps; 1.40 kΩ of row 716 corresponds to a three-wire grounded power cord used for 208 V and 240 V circuits rated for 20 amps; and 1.69 kΩ of row 718 corresponds to a three-wire grounded power cord used for 208 V and 240 V circuits rated for 30 amps.

Column 704 of LUT 700 shows that any of the 1.10, the 1.40 and the 1.69 kΩ resistor would indicate that the 2.5 kW heater may be used. On the other hand, for the 1.6 kW heater associated with column 706, only the 1.69 kΩ resistor may be used. Further, for the 0.9 kW heater associated with column 708, either the 1.40 or the 1.69 kΩ resistors may be used.

As further shown in LUT 700, column 710 indicates that for the 1.10 kΩ resistor associated with row 714, the compressor voltage is 20 V. Additionally, column 710 indicates that for the 1.40 kΩ resistor associated with row 716, the compressor voltage is 5 V. Finally, column 710 indicates that for the 1.69 kΩ resistor associated with row 718, the compressor voltage is 2 V.

The information in LUT 700 lists operating parameters based on the type of power cord as a priori information that is provided in the setup program 306.

Returning to FIG. 2, once the controller 206 determines the type of power cord is plugged into the receptacle 126, the controller 206 may operate the heater 208, the fan 210, and the compressor 212 in accordance with the optimum parameters associated with the corresponding power cord.

In the embodiment discussed above with reference to FIG. 3, the controlling unit 302 executes instructions in the setup program 306 to establish maximum operating parameters of the power cord 202. However, in other embodiments, a hard-wired system may be used to establish maximum operating parameters of the power cord 202.

FIG. 7B illustrates another example look-up table (LUT) 720 in accordance with one or more embodiments of the present disclosure. The LUT 720 includes a column of resistances in kilo-ohms, a column of a 2.5 kW heater, a column of 1.6 kW heater, a column of a 0.9 kW heater, a column of compressor voltage in volts, a column of fan voltage in volts, and several rows for different resistors from 1.10 to 3.30.

The information in LUT 720 lists operating parameters based on the type of power cord as a priori information that is provided in the setup program 306.

Returning to FIG. 2, once the controller 206 determines the type of power cord is plugged into the receptacle 126, the controller 206 may operate the heater 208, the fan 210, and the compressor 212 in accordance with the optimum parameters associated with the corresponding power cord.

In the embodiment discussed above with reference to FIG. 3, the controlling unit 302 executes instructions in the setup program 306 to establish maximum operating parameters of the power cord 202. However, in other embodiments, a hard-wired system may be used to establish maximum operating parameters of the power cord 202.

FIG. 8 illustrates an example controller 800 of the PTAC unit 100 of FIG. 2 in accordance with one or more embodiments of the present disclosure. The controller 800 includes a controlling unit 802 and a programmable logic array (PLA) 804. The controlling unit 802 and the PLA 804 are illustrated as individual devices. However, in some embodiments, the controlling unit 802 and the PLA 804 may be combined as a unitary device. Further, in some examples, the controlling unit 602 may be implemented as a computer having tangible computer-readable media for carrying or having computer-executable instructions or data structures stored thereon, which may include any computer program product, apparatus or device that can be used to carry or store desired computer-readable program code in the form of instructions or data structures and that can be accessed by a general-purpose or special-purpose computer, or a general-purpose or special-purpose processor.

In the embodiment of FIG. 8, the controlling unit 802 provides the value of the detected Vₒᵤₜ, as discussed above with reference to equation (1), to the PLA 804. As opposed to an LUT, the PLA 804 is configured to output the maximum operating parameters of the detected power cord.

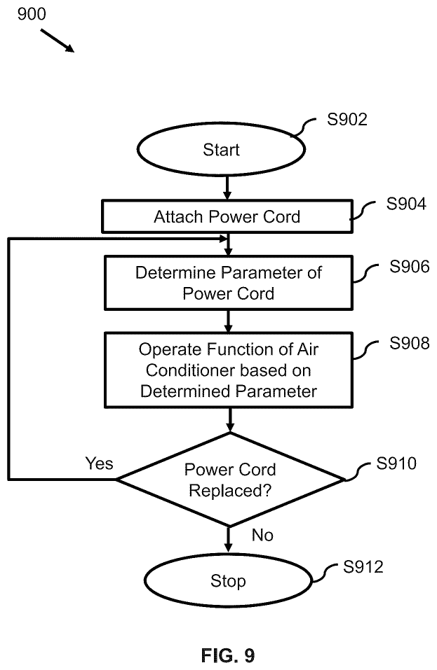

FIG. 9 illustrates a method 900 of operating the PTAC unit 100 of FIG. 2 in accordance with one or more embodiments of the present disclosure. The method 900 starts (S902) and a power cord is attached (S904). For example, as discussed above with reference to FIGS. 1B, 2, 4, and 5, a power cord is attached to the PTAC unit 300.

Returning to FIG. 9, after the power cord is attached (S904), a parameter of the power cord is determined (S906). For example, as discussed above with reference to FIG. 6, the resistance of the power cord may be determined by using a resistance in the PTAC unit 300 in conjunction with a resistance in the power cord as a voltage divider. The PTAC unit 300 may then supply a test voltage and measure the output voltage of the voltage divider to determine the resistance of the power cord.

In some embodiments, as discussed with reference to FIGS. 3 and 7, the controlling unit 302 of the controller 206 of the PTAC unit 100 may determine operating parameters of the PTAC unit 100 based on the determined resistance of the power cord by way of a priori information in the LUT 700. In other embodiments, as discussed with reference to FIG. 8, the controlling unit 802 of the controller 800 of a PTAC unit may determine operating parameters of the PTAC unit based on the determined resistance of the power cord by way of the PLA 804.

Returning to FIG. 9, after the parameter of the power cord is determined (S906), a function of the air conditioning unit is operated based on the determined parameter (S908). For example, as discussed above with reference to FIGS. 2 and 7, the controller 206 is configured to operate any of the heater 208, the fan 210, and the compressor 212 in accordance with maximum parameters from the LUT 700 that are associated with the determined resistance of the power cord.

Returning to FIG. 9, after a function of the air conditioning unit is operated based on the determined parameter (S908), it is determined whether the power cord has been replaced (S910). For example, there may be situations wherein the power cord the PTAC unit 100 is damaged and requires replacement. There is no guarantee that the replacement power cord is the same type of power cord as the previous damaged cord. Alternatively, there may be situations where the PTAC unit 100 is moved to a new installation that has a different voltage supply. For example, the PTAC unit might be moved from an industrial workplace having a voltage supply of 480 V to a residential housing complex having a voltage supply of 240 V. In this example, the industrial workplace may require one type of power cord, with its own resistance, whereas the residential housing complex may require a different type of power cord, with its own respective resistance. In either of these situations, if the power cord is replaced, the controller 206 is configured to detect a disconnection of power and a subsequent reconnection of power, thus indicating that the power cord might have been replaced.

Returning to FIG. 9, if it is determined that the power cord has not been replaced (e.g., No at S910), then method 900 stops (S912). However, if it is determined that the power cord has been replaced (e.g., Yes at S910), then the parameter of the power cord is again determined (S906) and method 900 continues.

Typical PTAC units may be configured to operate from a plurality of different power cords. However, a technician may be need to configure the PTAC unit for each respective power cord, which may take time and increase cost. In accordance with a PTAC unit of one or more embodiments of the present disclosure, the controller of the PTAC unit is able to identify a power cord via an impedance element in the power cord. After identifying the power cord, the controller of the PTAC unit is able to reconfigure the operating elements therein so as to optimize operation using the identified power cord. This automated method of optimizing the PTAC unit may decrease the setup time and the cost of operation of the PTAC unit.

It should be apparent that the foregoing relates only to certain embodiments of the present disclosure and that numerous changes and modifications may be made herein by one of ordinary skill in the art without departing from the general spirit and scope of the disclosure.

Although specific embodiments of the disclosure have been described, numerous other modifications and alternative embodiments are within the scope of the disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A device for use with a detachable power cord having a plug, the device comprising:
a receptacle configured to receive the plug;
a circuit configured to determine a maximum operating parameter of the detachable power cord; and
a controller configured to operate a function of the device based on the determined maximum operating parameter of the detachable power cord.

2. The device of claim 1, wherein the circuit is configured to determine a maximum operating current of the detachable power cord as the determined maximum operating parameter of the detachable power cord.

3. The device of claim 1, further comprising:
a fan;
a heater; and
a condenser,
wherein the controller is configured to operate, as the function of the device, at least one of the fan, the heater, and the condenser based on the determined maximum operating parameter of the detachable power cord.

4. The device of claim 1, wherein the circuit comprises a resistor to be used in conjunction with the plug to form a voltage divider.

5. The device of claim 1, wherein the plug comprises a three-wire grounding plug used for 208 V circuits, a three-wire grounding plug used for 240 V circuits, and/or a two-pole and ground plug used for 277 V circuits.

6. The device of claim 1, further comprising a memory having a data structure stored therein associating the function of the device with an a priori maximum operating parameter of the detachable power cord,
wherein the controller is configured to access the data structure to operate the function of the device based on the determined maximum operating parameter of the detachable power cord and the a priori maximum operating parameter of the detachable power cord.

7. The device of claim 1,
wherein the controller comprises a programmable logic array associating the function of the device with an a priori maximum operating parameter of the detachable power cord, and
wherein the controller is configured to operate the function of the device based on the determined maximum operating parameter of the detachable power cord and the a priori maximum operating parameter of the detachable power cord.

8. A device comprising:
a detachable power cord having a plug;
a receptacle configured to receive the plug;
a circuit configured to determine a maximum operating parameter of the detachable power cord; and
a controller configured to operate a function of the device based on the determined maximum operating parameter of the detachable power cord.

9. The device of claim 8, wherein the circuit is configured to determine a maximum operating current of the detachable power cord as the determined maximum operating parameter of the detachable power cord.

10. The device of claim 8, further comprising:
a fan;
a heater; and
a condenser,
wherein the controller is configured to operate, as the function of the device, at least one of the fan, the heater, and the condenser based on the determined maximum operating parameter of the detachable power cord.

11. The device of claim 8,
wherein the circuit comprises a circuit resistor,
wherein the plug comprises a plug resistor, and
wherein the circuit resistor and the plug resistor form a voltage divider.

12. The device of claim 8, further comprising:
a memory having a data structure stored therein associating the function of the device with an a priori maximum operating parameter of the detachable power cord,
wherein the controller is configured to access the data structure to operate the function of the device based on the determined maximum operating parameter of the detachable power cord and the a priori maximum operating parameter of the detachable power cord.

13. The device of claim 8,
wherein the controller comprises a programmable logic array associating the function of the device with an a priori maximum operating parameter of the detachable power cord, and
wherein the controller is configured to operate the function of the device based on the determined maximum operating parameter of the detachable power cord and the a priori maximum operating parameter of the detachable power cord.

14. A method of operating a device, the method comprising:
attaching a detachable power cord having a plug into a receptacle configured to receive the plug;
determining, via a circuit, a maximum operating parameter of the detachable power cord; and
operating, via a controller, a function of the device based on the determined maximum operating parameter of the detachable power cord.

15. The method claim 14, wherein the determining a maximum operating parameter of the detachable power cord comprises determining a maximum operating current of the detachable power cord as the determined maximum operating parameter of the detachable power cord.

16. The method of claim 14, wherein the controller is configured to operate, as the function of the device, at least one of a fan, a heater, and a condenser based on the determined maximum operating parameter of the detachable power cord.

17. The method of claim 14,
wherein the circuit comprises a circuit resistor,
wherein the plug comprises a plug resistor, and
wherein the circuit resistor and the plug resistor form a voltage divider based on the plug being plugged into the receptacle.

18. The method of claim 14,
wherein the operating, via the controller, the function of the device based on the determined maximum operating parameter of the detachable power cord comprises operating the function of the device via the controller including a memory having a data structure stored therein associating the function of the device with an a priori maximum operating parameter of the detachable power cord, and
wherein the operating, via the controller, the function of the device based on the determined maximum operating parameter of the detachable power cord further comprises accessing, via the controller, the data structure to operate the function of the device based on the determined maximum operating parameter of the detachable power cord and the a priori maximum operating parameter of the detachable power cord.

19. The method of claim 14,
wherein the operating, via the controller, the function of the device based on the determined maximum operating parameter of the detachable power cord comprises operating the function of the device via the controller including a programmable logic array associating the function of the device with an a priori maximum operating parameter of the detachable power cord, and
wherein the operating, via the controller, the function of the device based on the determined maximum operating parameter of the detachable power cord further comprises operating, via the controller, the function of the device based on the determined maximum operating parameter of the detachable power cord and the a priori maximum operating parameter of the detachable power cord.

20. The method of claim 14, further comprising:
detaching the detachable power cord from the receptacle configured to receive the plug; and
attaching a second detachable power cord having a second plug into the receptacle configured to receive the second plug;
determining, via the circuit, a maximum operating parameter of the second detachable power cord; and
operating, via the controller, the function of the device based on the determined maximum operating parameter of the second detachable power cord.
